(19) United States
(12) Patent Application Publication
(10) Pub. No.: US 2012/0165232 A1
(43) Pub. Date: Jun. 28, 2012

(54) Methods of Controlling the Degradation Rate of Hydrolytically Degradable Materials

(76) Inventors: Bradley L. Todd, Duncan, OK (US); Michael N. Mang, Eden Prairie, MN (US); Thomas D. Welton, Duncan, OK (US); Trinidad Munoz, JR., Duncan, OK (US); Matthew E. Blauch, Duncan, OK (US)

(21) Appl. No.: 13/412,404

(22) Filed: Mar. 5, 2012

Related U.S. Application Data
(63) Continuation of application No. 11/147,093, filed on Jun. 7, 2005, now abandoned.

(51) Int. Cl. C09K 8/00

(52) U.S. Cl. 507/216

(57) ABSTRACT

Methods of affecting the rate at which a hydrolytically degradable material degrades comprising: providing a hydrolytically degradable material, the degradable material having an intrinsic degradation rate; providing a modifier, the modifier being capable of affecting the intrinsic degradation rate of the hydrolytically degradable material; placing the hydrolytically degradable material and the modifier into a subterranean formation; and allowing the modifier to affect the intrinsic degradation rate of the hydrolytically degradable material so that the hydrolytically degradable material degrades at a second degradation rate.

### BACKGROUND

The present invention relates to the use of modifiers to affect the rate at which hydrolytically degradable materials degrade in a subterranean environment.

Hydrolytically degradable materials are increasingly becoming of interest in various subterranean applications based, at least in part, on their ability to degrade and leave voids, act as a temporary restriction to the flow of a fluid, or produce desirable degradation products (e.g., acids). One particular hydrolytically degradable material that has received recent attention is poly(lactic acid) (“PLA”) because it is a material that will degrade down hole after it has performed a desired function or because its degradation products will perform a desired function (e.g., degrade an acid soluble component). Hydrolytically degradable materials may also be used to leave voids behind upon degradation to improve the permeability of a given structure. For instance, when a proppant pack is created comprising proppant particulates and hydrolytically degradable materials and when the hydrolytically degradable material degrades, a proppant pack having voids therein is formed. Similarly, voids also may be created in a set cement in a subterranean environment. Moreover, hydrolytically degradable materials may be used as coating to temporarily protect a coated object or chemical from exposure to the well bore environment. For example, a breaker or some other treatment chemical may be coated, encapsulated, or encaged in poly(lactic acid) and used in a subterranean operation such that the breaker is not substantially exposed to the subterranean environment until the poly(lactic acid) coating substantially degrades. Still another use for hydrolytically degradable materials in subterranean operations involves creating down hole tools or parts of down hole tools out of solid masses of a hydrolytically degradable materials and using those tools down hole. In such operations, the hydrolytically degradable material may be designed such that it does not substantially degrade until the tool has substantially completed its desired tool function. Still other uses for hydrolytically degradable materials in subterranean operations include their use as diverting agents, bridging agents, and fluid loss control agents.

Regardless of the chosen use for the hydrolytically degradable material, the rate at which it degrades is as least somewhat important. For instance, a diverting agent formed from a solid particulate hydrolytically degradable material would be of little or no use if it degraded so rapidly it was placed in the portion of the subterranean formation from which diversion was desired. Similarly, a tool formed of a hydrolytically degradable material that lost its necessary structure before its job was complete could only hope to be moderately successful. While it is possible to “tune” the properties of the hydrolytically degradable material (such as by the initial choice of the hydrolytically degradable material, choice of plasticizers, molecular weight of the hydrolytically degradable material, etc.), such modifications may not be sufficient to extend or decrease the degradation time appropriately or may not be economically practical. Thus, what is needed is a relatively low-cost method of altering the rate at which water contacts the hydrolytically degradable material and, thus, altering the rate at which the hydrolytically degradable material will degrade.

### SUMMARY

The present invention relates to the use of modifiers to affect the rate at which hydrolytically degradable materials degrade in a subterranean environment.

In one embodiment, the present invention provides a method of affecting the rate at which a hydrolytically degradable material degrades comprising: providing a hydrolytically degradable material, the degradable material having an intrinsic degradation rate; providing a modifier, the modifier being capable of affecting the intrinsic degradation rate of the hydrolytically degradable material; placing the hydrolytically degradable material and the modifier into a subterranean formation; and allowing the modifier to affect the intrinsic degradation rate of the hydrolytically degradable material.

In another embodiment, the present invention provides a method comprising: providing a treatment fluid that comprises a base fluid, a hydrolytically degradable material that has an intrinsic degradation rate; and a modifier that is capable of affecting the intrinsic degradation rate of the hydrolytically degradable material; placing the treatment fluid into a subterranean formation; allowing the modifier to affect the intrinsic degradation rate of the hydrolytically degradable material; and allowing the hydrolytically degradable material to degrade to produce degradation products.

In another embodiment, the present invention provides a subterranean treatment fluid system comprising: a hydrolytically degradable material, the hydrolytically degradable material having an intrinsic degradation rate; and a modifier, the modifier being capable of affecting the intrinsic degradation rate of the hydrolytically degradable material by affecting the rate at which an aqueous fluid will contact the hydrolytically degradable material.

The features and advantages of the present invention will be apparent to those skilled in the art. While numerous changes may be made by those skilled in the art, such changes are within the spirit of the invention.

### DESCRIPTION OF THE PREFERRED EMBODIMENTS

The present invention relates to the use of modifiers to affect the rate at which hydrolytically degradable materials degrade in a subterranean environment. More particularly, the methods of the present invention provide methods of using modifiers to alter the rate at which hydrolytically degradable materials will degrade when contacted with an aqueous fluid.

The methods of the present invention involve the use of a modifier to affect the intrinsic rate at which a hydrolytically degradable material degrades in a given subterranean environment. The term “intrinsic rate” as used herein refers to the degradation rate at which a chosen hydrolytically degradable material will degrade in a given subterranean environment if a modifier of the present invention is not used. The modifiers of the present invention are capable of affecting the rate at which a given aqueous fluid (e.g., one present in the subterranean formation, a treatment fluid added to the subterranean formation, etc.) interacts with the degradable material. As a result, the intrinsic degradation rate of the hydrolytically degradable material should be affected either positively or negatively, depending on the modifier, hydrolytically degradable material, aqueous fluid, and method of use, so that it degrades at a second degradation rate. In some embodiments, the modifier may accelerate the rate at which the hydrolytically degradable material degrades. For example, a more hydrophilic modifier may act as a sort of attractant to water present in the formation, and thereby increase the rate of degradation. In other embodiments, the modifier may slow the rate of degradation. In such embodiments, the modifier may be hydrophobic in nature so that it acts as sort of a repellant to water present in the formation, and the rate at which the hydrolytically degradable material degrades may be decreased.

In certain embodiments, the modifier is intended as an interfacial component that coats as a discrete layer or associates in use in such a way as to alter the interaction between the degradable material and the surrounding environment. This may be at least somewhat distinguishable from instances wherein the surrounding environment itself is altered to such an extent that the activity of the environment for the degradable material is altered (e.g., by replacing any aqueous-based fluids present therein with nonaqueous-based fluids). In some embodiments of the present invention, the hydrolytically degradable material may be at least partially or wholly coated or otherwise incorporated with a suitable modifier before being placed into the subterranean formation. In other embodiments, a suitable modifier may be included as a component in a treatment fluid comprising a hydrolytically degradable material. In all embodiments, the modifier is used in a relatively small amount as opposed to situations wherein the entire surrounding environment is replaced with a modifier.

Nonlimiting examples of hydrolytically degradable materials that may be used in conjunction with the present invention include but are not limited to hydrolytically degradable monomers, oligomers, and polymers, and/or mixtures of the two. Other suitable hydrolytically degradable materials include insoluble esters that are not polymerizable. Such esters include formates, acetates, benzoate esters, phthalate esters, and the like. Blends of any of these also may be suitable. For instance, polymer/polymer blends or monomer/polymer blends may be suitable. Such blends may be useful to affect the intrinsic degradation rate of the hydrolytically degradable material. These suitable hydrolytically degradable materials also may be blended with suitable fillers (e.g., particulate or fibrous fillers to increase modulus) if desired.

In choosing the appropriate hydrolytically degradable material, one should consider the degradation products that will result. Also, these degradation products should not adversely affect other operations or components. The choice of hydrolytically degradable material also can depend, at least in part, on the conditions of the well, e.g., well bore temperature. For instance, lactides may be suitable for use in lower temperature wells, including those within the range of 60° F. to 150° F., and polylactides may be suitable for use in well bore temperatures above this range.

The degradability of a polymer depends at least in part on its backbone structure. The rates at which such polymers degrade are dependent on the type of repetitive unit, composition, sequence, length, molecular geometry, molecular weight, morphology (e.g., crystallinity, size of spherulites, and orientation), hydrophilicity, hydrophobicity, surface area, and additives. Also, the environment to which the polymer is subjected may affect how it degrades, e.g., temperature, amount of water, oxygen, microorganisms, enzymes, pH, and the like.

Some suitable hydrolytically degradable monomers include lactide, lactones, glycolides, anhydrides, and lactams.

Some suitable examples of hydrolytically degradable polymers that may be used in accordance with the present invention include, but are not limited to, those described in the publication of Advances in Polymer Science, Vol. 157 entitled “Degradable Aliphatic Polyesters” edited by A. C. Albertsson. Specific examples include homopolymers, random, block, graft, and star- and hyper-branched aliphatic polyesters. Such suitable polymers may be prepared by polycondensation reactions, ring-opening polymerizations, free radical polymerizations, anionic polymerizations, carbocationic polymerizations, and coordinative ring-opening polymerization for, e.g., lactones, and any other suitable process. Specific examples of suitable polymers include polysaccharides such as dextran or cellulose; chitin; chitosan; proteins; aliphatic polyesters; poly(lactides); poly(glycolides); poly(ε-caprolactones); poly(hydroxybutyrates); aliphatic polycarbonates; poly(orthoesters); poly(amides); poly(urethanes); poly(hydroxy ester ethers); poly(anhydrides); aliphatic polycarbonates; poly(orthoesters); poly(amino acids); poly(ethylene oxide); and polyphosphazenes. Of these suitable polymers, aliphatic polyesters and polyanhydrides are preferred. Of the suitable aliphatic polyesters, poly(lactide) and poly(glycolide), or copolymers of lactide and glycolide, may be preferred.

The lactide monomer exists generally in three different forms: two stereoisomers L- and D-lactide and racemic D,L-lactide (meso-lactide). The chirality of lactide units provides a means to adjust, among other things, degradation rates, as well as physical and mechanical properties. Poly(L-lactide), for instance, is a semi-crystalline polymer with a relatively slow hydrolysis rate. This could be desirable in applications of the present invention where a slower degradation of the hydrolytically degradable material is desired. Poly(D,L-lactide) may be a more amorphous polymer with a resultant faster hydrolysis rate. This may be suitable for other applications where a more rapid degradation may be appropriate. The stereoisomers of lactic acid may be used individually or combined in accordance with the present invention. Additionally, they may be copolymerized with, for example, glycolide or other monomers like c-caprolactone, 1,5-dioxepan-2-one, trimethylene carbonate, or other suitable monomers to obtain polymers with different properties or degradation times. Additionally, the lactic acid stereoisomers can be modified by blending high and low molecular weight poly(lactide) or by blending poly(lactide) with other polyesters.

Plasticizers may be present in the hydrolytically degradable materials if desired. Suitable plasticizers include, but are not limited to, derivatives of oligomeric lactic acid, polyethylene glycol; polyethylene oxide; oligomeric lactic acid; citrate esters (such as tributyl citrate oligomers, triethyl citrate, acetyltributyl citrate, acetyltriethyl citrate); glucose monoesters; partially fatty acid esters; PEG monolaurate; triacetin; poly(ε-caprolactone); poly(hydroxybutyrate); glycerin-1-benzoate-2,3-dilaurate; glycerin-2-benzoate-1,3-dilaurate; starch; bis(butyl diethylene glycol)adipate; ethylphthalylethyl glycolate; glycerine diacetate monocaprylate; diacetyl monoacyl glycerol; polypropylene glycol (and epoxy, derivatives thereof); poly(propylene glycol)dibenzoate, dipropylene glycol dibenzoate; glycerol; ethyl phthalyl ethyl glycolate; poly(ethylene adipate)distearate; di-iso-butyl adipate; and combinations thereof.

The physical properties of hydrolytically degradable polymers depend on several factors such as the composition of the repeat units, flexibility of the chain, presence of polar groups, molecular mass, degree of branching, crystallinity, orientation, etc. For example, short chain branches reduce the degree of crystallinity of polymers while long chain branches lower the melt viscosity and impart, among other things, elongational viscosity with tension-stiffening behavior. The properties of the material utilized can be further tailored by blending, and copolymerizing it with another polymer, or by a change in the macromolecular architecture (e.g., hyper-branched polymers, star-shaped, or dendrimers, etc.). The properties of any such suitable degradable polymers (e.g., hydrophobicity, hydrophilicity, rate of degradation, etc.) can be tailored by introducing select functional groups along the polymer chains. For example, poly(phenyllactide) will degrade at about ⅕th of the rate of racemic poly(lactide) at a pH of 7.4 at 55° C. One of ordinary skill in the art with the benefit of this disclosure will be able to determine the appropriate functional groups to introduce to the polymer chains to achieve the desired physical properties of the degradable polymers.

Polyanhydrides are another type of particularly suitable degradable polymer useful in the present invention. Examples of suitable polyanhydrides include poly(adipic anhydride), poly(suberic anhydride), poly(sebacic anhydride), and poly(dodecanedioic anhydride). Other suitable examples include, but are not limited to, poly(maleic anhydride) and poly(benzoic anhydride).

Modifiers suitable for use in the present invention may be those that that are more hydrophilic in nature (that may accelerate the rate which water contacts the hydrolytically degradable material), or those that are more hydrophobic in nature (that may decelerate the rate which water contacts the hydrolytically degradable material).

Examples of suitable more hydrophilic modifiers include hydrophilic surfactants with groups such as sulfates, sulfonates, phosphates, oxyalkalates, carboxylates, ethers, amines (primary, secondary, tertiary, or quaternary), pyridiniums, polyoxyethylenes, monoglycerides, diglycerides, acetylenic glycols, pyrrolidines, alcohol amines, polyglycosides, sorbides, aminecarboxylates, betaines, sulfobetaines, or amine oxides. Other suitable hydrophilic modifiers include starches of the general formula (C₆H₁₀O₅)ₙ, and may be derived from corn, wheat, oats, rice, potatoes, tapioca, yucca, and the like. Generally, suitable starches comprise a mixture of a linear polymer (amylose) and a branched polymer (amylopectin) that are intertwined within starch granules. One should note though that pure amylose and amylopectin are suitable starches. Still other suitable hydrophilic modifiers include poly(ethers), glycols, glycol ethers, or esters of glycol ethers, such as ethylene glycol, propylene glycol, poly ethylene glycols, poly propylene glycols, ethylene glycol monomethyl ether, ethylene glycol monoethyl ether, ethylene glycol, monoethyl ether acetate, ethylene glycol monobutyl ether, ethylene glycol monobutyl ether acetate, ethylene glycol monopropyl ether, ethylene glycol monophenyl ether, ethylene glycol monohexyl ether, ethylene glycol mono 2-ethylhexyl ether, diethylene glycol monomethyl ether, diethylene glycol monoethyl ether, diethylene glycol monoethyl ether acetate, diethylene glycol monobutyl ether, diethylene glycol monobutyl ether acetate, diethylene glycol monopropyl ether, diethylene glycol monohexyl ether, triethylene glycol monomethyl ether, triethylene glycol monoethyl ether, triethylene glycol monobutyl ether, triethylene glycol monopropyl ether, mixtures thereof and the like.

Examples of suitable more hydrophobic modifiers include hydrophobic surfactants containing groups such as linear or branched saturated alkyl, linear or branched unsaturated alkyl, alkyldiphenyl ethers, polyoxypropylene, polyoxybutylene, polysiloxanes, perfluoroalkyls, or lignins. Other suitable hydrophobic modifiers include waxes such as hydrogenated vegetable oils (such as soybean), vegetable waxes (such as carnauba, candelilla, ouricouri, palm wax, jojoba oil, and the like), animal waxes, synthetic waxes (such as CARBOWAX™, polyethylenes, polymethylenes, and amide waxes), paraffin waxes, and microcrystalline waxes. Still other suitable hydrophobic modifiers include oils such as hydrocarbon based oils (mineral oils and the like), vegetable oils (soy, rapeseed, sunflower, corn, and the like), silicone oils, and the like.

In embodiments wherein a solid hydrolytically degradable material is coated with a modifier, the chosen modifier may be coated onto the hydrolytically degradable material by any means known in the art, including but not limited to, spray-coating, fluidized bed coating, tumble mixing, and other known methods. The term “coating” or any of its derivatives as used herein does not imply an absolute of 100% coverage of the hydrolytically degradable material. In some embodiments of the present invention wherein the chosen modifier coating is a polymer or oligomer, it may be covalently linked to the degradable material or crosslinked, among other things, to ensure the chosen modifier coating remains in place on the hydrolytically degradable material once the modifier coated hydrolytically degradable material is placed into an aqueous environment. Preferably, the modifier coating is placed on the hydrolytically degradable material such that it covers substantially the entire exposed surface of the hydrolytically degradable material.

Moreover, in embodiments wherein the modifier is used as a coating, it may be desirable to use of multiple layers of coatings. In some embodiments, multiple layers of coatings may be used over the hydrolytically degradable material itself. For instance, it may be desirable to have multiple layers of a hydrophobic surfactant in circumstances wherein it is desirable to slow the rate at which water contacts the hydrolytically degradable material further than a single coating would provide. In other embodiments, it may be desirable to slow the rate at which water contacts the hydrolytically degradable material in the beginning of a subterranean operation and then speed it the rate at which water contacts the hydrolytically degradable material later in the operation. In such a circumstance a hydrolytically degradable material may be coated first with a hydrophilic modifier and then with a hydrophobic modifier.

In alternative embodiments, suitable modifiers may be used to affect the degradation of hydrolytically degradable materials that are placed in the well bore in a different form than particles, fibers, etc. An example would be where an actual physical tool or a part of a tool that is placed in a subterranean formation is made from a degradable material. Such physical objects (tools, screens, etc.) are described, for example, in U.S. patent application Ser. No. 10/803,668, filed on Mar. 17, 2004 and titled “One-Time Use Composite Tool Formed of Fibers and a Biodegradable Resin,” the relevant disclosure of which is hereby incorporated by reference. In some embodiments of the present invention a modifier may be used to alter the rate of degradation of the hydrolytically degradable material portion of such an object. In still other embodiments, a physical object used in a subterranean environment may be constructed out of traditional, non-degradable materials but then may be coated with a hydrolytically degradable material. For example, a traditional gravel packing screen may be coated with poly(lactic acid) before it is placed into a well bore. In some methods of the present invention a modifier may be used to alter the rate of degradation of the coating.

To facilitate a better understanding of the present invention, the following examples of certain aspects of some embodiments are given. In no way should the following examples be read to limit, or define, the scope of the invention.

### EXAMPLES

### Example 1

### Coating a Hydrolytically Degradable Material with a Hydrophobic Surfactant

A viscosified fluid was first prepared by: mixing for ten minutes 94.5 mL of 11.6 lb/gal CaCl₂ solution with 15.05 mL of modified hydroxyethyl cellulose polymer (the polymer used is commercially available under tradename WG-33 from Halliburton Energy Services of Duncan, Okla.); adding 1.75 mL of 20° Be HCl and allowing it to mix for 5 minutes; and, adding 220.5 mL of propylene glycol and mixing until all the components are well mixed (about 2 minutes) and then allowing the mixture to hydrate for at least one hour under no shear.

Five grams of uncoated degradable material, 150 micron powder of poly(lactic acid), was added to 200 mL of the viscosified fluid along with one gram of a pH sensitive magnesium oxide crosslinking agent (the magnesium oxide crosslinking agent used is commercially available under tradename CL-30 from Halliburton Energy Services of Duncan, Okla.). The mixture was allowed to sit at room temperature for about 1 hour until the crosslink was complete and then the crosslinked gel comprising the uncoated degradable material was placed in an oven at 220° F. Table 1, below shows the results of how long the uncoated degradable material took to degrade sufficiently to produce enough acid to de-link the crosslinked fluid.

Next, a coated degradable material was prepared by coating 5 g of 150 micron powder of poly(lactic acid) with 0.1 g of a mixture of Ethoduomeen T/13 and propylene glycol (wherein the mixture contains 3 mL of Ethoduomeen T/13 to every 1 mL of propylene glycol). The propylene glycol was used to dilute the Ethoduomeen T/13 for ease of handling. The resultant material was a coated degradable material having an about 2% coating. Ethoduomeen T/13 is a hydrophobic surfactant.

Next, all of the coated degradable material was added to 200 mL of the viscosified fluid along with one gram of a pH sensitive magnesium oxide crosslinking agent (the magnesium oxide crosslinking agent used is commercially available under tradename CL-30 from Halliburton Energy Services of Duncan, Okla.). The mixture was allowed to sit at room temperature for about 1 hour until the crosslink was complete and then the crosslinked gel comprising the coated degradable material was placed in an oven at 220° F. Table 2, below shows the results of how long the coated degradable material took to degrade sufficiently to produce enough acid to de-link the crosslinked fluid.

TABLE 1

| Day/Time | Action/Status |
|---|---|
| Day 1, 3:30 PM | crosslinked gel comprising the coated degradable material |
| | was placed in an oven at 220° F. |
| Day 3, 8:30 AM | crosslinked gel showed begin to show signs of de-linking |
| Day 4, 8:30 AM | crosslinked gel had de-linked considerably |
| Day 6, 8:30 AM | crosslinked gel had substantially de-linked with little |
| | evidence of crosslinked gel remaining |

TABLE 2

| Day/Time | Action/Status |
|---|---|
| Day 1, 3:30 PM | crosslinked gel comprising the coated degradable |
| | material was placed in an oven at 220° F. |
| Day 3, 8:30 AM | crosslinked gel showed no signs of de-linking, still well |
| | crosslinked |
| Day 8, 8:30 AM | crosslinked gel had de-linked somewhat, a region of |
| | crosslinked gel remained evident |
| Day 9, 8:30 AM | crosslinked gel had substantially de-linked, though a thin |
| | region of crosslinked gel remained |

The test was run again but with twice the amount of coated degradable material. Table 3, below shows the results of how long the coated degradable material took to degrade sufficiently to produce enough acid to de-link the crosslinked fluid.

TABLE 3

| Day/Time | Action/Status |
|---|---|
| Day 1, 3:40 PM | crosslinked gel comprising the coated degradable material |
| | was placed in an oven at 220° F. |
| Day 2, 8:30 AM | crosslinked gel showed slight signs of de-linking, still well |
| | crosslinked |
| Day 4, 8:30 AM | approximately ¾ of the crosslinked gel had de-linked, a |
| | region of crosslinked gel remained evident |
| Day 7, 8:30 AM | crosslinked gel completely de-linked |

### Example 2

### Adding a Hydrophilic Surfactant to a Treatment Fluid

In this example, a hydrolytically degradable material that degrades to produce an acid was used to de-link a crosslinked fluid that had been crosslinked with a pH sensitive crosslinking agent. A viscosified fluid was first prepared by: mixing 94.5 mL of 11.6 #/gal CaCl₂ solution with 15.05 mL of a crosslinkable hydroxy ethyl cellulose polymer (tradename WG-33, commercially available from Halliburton Energy Services of Duncan, Okla.) and allowing it to mix for ten minutes; adding 1.75 mL of 20° Be HCl and allowing it to mix for 5 minutes; and adding 220.5 mL of propylene glycol and allowing it to mix for at least 2 minutes or until all the components are well mixed and then allow to hydrate for at least one hour under no shear.

Next, 10 grams of poly(lactic acid) was added to 200 mL of the viscosified fluid and one gram of a pH sensitive magnesium oxide crosslinking agent (the magnesium oxide crosslinking agent used is commercially available under tradename CL-30 from Halliburton Energy Services of Duncan, Okla.). The mixture was allowed to sit at room temperature for about 1 hour until the crosslink was complete and then the crosslinked gel comprising the coated degradable material was placed in a hybrid HPHT Model 90 at 220° F. The material took 48 hours to degrade sufficiently to produce enough acid to de-link the crosslinked fluid.

Next, the test was run again but 0.2 grams of sodium dodecyl sulfate (a hydrophilic surfactant) was added to the viscosified fluid before the poly(lactic acid) and crosslinking agent were added. The material took only 6 hours to degrade sufficiently to produce enough acid to de-link the crosslinked fluid. Thus, this example demonstrates that adding a hydrophilic surfactant to the fluid can increase the rate of degradation of the PLA.

Therefore, the present invention is well adapted to attain the ends and advantages mentioned as well as those that are inherent therein. While numerous changes may be made by those skilled in the art, such changes are encompassed within the spirit of this invention as defined by the appended claims. The terms in the claims have their plain, ordinary meaning unless otherwise explicitly and clearly defined by the patentee.

1-20. (canceled)

21. A method comprising:
providing a treatment fluid;
providing a solid hydrolytically degradable material coated with a modifier wherein the modifier and the solid hydrolytically degradable material are not identical;
wherein the solid hydrolytically degradable material is selected from the group consisting of: a benzoate ester; a phthalate ester; a lactide; a lactone; a lactam; dextran; chitin; chitosan; a protein; an aliphatic polyester; a poly(lactide); a poly(ε-caprolactone); a poly(hydroxybutyrate); a polyanhydride; an aliphatic polycarbonate; a poly(amide); a poly(urethane); a poly(amino acid); and polyphosphazene;
slurrying the solid hydrolytically degradable material coated with the modifier into the treatment fluid; and,
placing the slurry into a subterranean formation;
allowing the modifier to either attract water to or to repel water from the covered hydrolytically degradable material; and
allowing the hydrolytically degradable material to degrade to produce degradation products.

22. The method of claim 21 wherein the modifier increases the intrinsic degradation rate of the hydrolytically degradable material.

23. The method of claim 21 wherein the modifier decreases the intrinsic degradation rate of the hydrolytically degradable material.

24. The method of claim 21 wherein the modifier comprises at least one of the following: a hydrophilic modifier or a hydrophobic modifier.

25. The method of claim 21 wherein the modifier is a hydrophilic modifier selected from the group consisting of: a sulfate; a sulfonate; a phosphate; an oxyalkylate; an ether; an amine; a pyridinium; a monoglyceride; a diglyceride; an acetylenic glycol; a pyrrolidine; an alcohol amine; a polyglycoside; a sorbide; an amine carboxylate; a betaine; a sulfobetaine; an amine oxide; a glycol; a glycol ether; an ester of a glycolether; a hydrophilic surfactant; a starch according to the formula (C₆H10O5)n; a poly(ether); ethylene glycol; propylene glycol; poly ethylene glycol; poly propylene glycol; ethylene glycol monomethyl ether; ethylene glycol monoethyl ether; ethylene glycol; monoethyl ether acetate; ethylene glycol monobutyl ether; ethylene glycol monobutyl ether acetate; ethylene glycol monopropyl ether; ethylene glycol monophenyl ether; ethylene glycol monohexyl ether; ethylene glycol mono 2-ethylhexyl ether; diethylene glycol monomethyl ether; diethylene glycol monoethyl ether; diethylene glycol monoethyl ether acetate; diethylene glycol monobutyl ether; diethylene glycol monobutyl ether acetate; diethylene glycol monopropyl ether; diethylene glycol monohexyl ether; triethylene glycol monomethyl ether; triethylene glycol monoethyl ether; triethylene glycol monobutyl ether; and triethylene glycol monopropyl ether.

26. The method of claim 21 wherein the modifier is a hydrophobic modifier selected from the group consisting of: a linear or branched saturated alkyl; a linear or branched unsaturated alkyl; an alkyldiphenyl ether; a hydrophobic surfactant; polyoxypropylene; polyoxybutylene; a polysiloxane; a perfluoroalkyl; a lignin; a wax; a hydrogenated vegetable oil; a vegetable wax; an animal wax; a synthetic wax; a paraffin wax; a microcrystalline wax; an oil; a hydrocarbon based oil; a vegetable oil; and a silicone oil.

27. A method of changing the rate at which a hydrolytically degradable material degrades comprising:
providing a treatment fluid;
providing a solid hydrolytically degradable material coated with a modifier wherein the modifier and the solid hydrolytically degradable material are not identical;
wherein the solid hydrolytically degradable material is selected from the group consisting of: a benzoate ester; a phthalate ester; a lactide; a lactone; a lactam; dextran; chitin; chitosan; a protein; an aliphatic polyester; a poly(lactide); a poly(ε-caprolactone); a poly(hydroxybutyrate); a polyanhydride; an aliphatic polycarbonate; a poly(amide); a poly(urethane); a poly(amino acid); and polyphosphazene;
slurrying the solid hydrolytically degradable material coated with the modifier into the treatment fluid; and,
placing the slurry into a subterranean formation such that the modifier either attracts water to or repels water from the covered hydrolytically degradable material;
wherein the hydrolytically degradable material is solid and wherein the modifier is coated onto the solid hydrolytically degradable material before placing into a subterranean formation.

28. The method of claim 27 wherein the modifier increases the intrinsic degradation rate of the hydrolytically degradable material.

29. The method of claim 27 wherein the modifier decreases the intrinsic degradation rate of the hydrolytically degradable material.

30. The method of claim 27 wherein the modifier comprises at least one of the following: a hydrophilic modifier or a hydrophobic modifier.

31. The method of claim 27 wherein the modifier is a hydrophilic modifier selected from the group consisting of: a sulfate; a sulfonate; a phosphate; an oxyalkylate; an ether; an amine; a pyridinium; a monoglyceride; a diglyceride; an acetylenic glycol; a pyrrolidine; an alcohol amine; a polyglycoside; a sorbide; an amine carboxylate; a betaine; a sulfobetaine; an amine oxide; a glycol; a glycol ether; an ester of a glycolether; a hydrophilic surfactant; a starch according to the formula (C6H10O5)n; a poly(ether); ethylene glycol; propylene glycol; poly ethylene glycol; poly propylene glycol; ethylene glycol monomethyl ether; ethylene glycol monoethyl ether; ethylene glycol; monoethyl ether acetate; ethylene glycol monobutyl ether; ethylene glycol monobutyl ether acetate; ethylene glycol monopropyl ether; ethylene glycol monophenyl ether; ethylene glycol monohexyl ether; ethylene glycol mono 2-ethylhexyl ether; diethylene glycol monomethyl ether; diethylene glycol monoethyl ether; diethylene glycol monoethyl ether acetate; diethylene glycol monobutyl ether; diethylene glycol monobutyl ether acetate; diethylene glycol monopropyl ether; diethylene glycol monohexyl ether; triethylene glycol monomethyl ether; triethylene glycol monoethyl ether; triethylene glycol monobutyl ether; and triethylene glycol monopropyl ether.

32. The method of claim 27 wherein the modifier is a hydrophobic modifier selected from the group consisting of: a linear or branched saturated alkyl; a linear or branched unsaturated alkyl; an alkyldiphenyl ether; a hydrophobic surfactant; polyoxypropylene; polyoxybutylene; a polysiloxane; a perfluoroalkyl; a lignin; a wax; a hydrogenated vegetable oil; a vegetable wax; an animal wax; a synthetic wax; a paraffin wax; a microcrystalline wax; an oil; a hydrocarbon based oil; a vegetable oil; and a silicone oil.

33. A method comprising:
providing a treatment fluid;
providing a solid hydrolytically degradable material coated with a modifier wherein the modifier and the solid hydrolytically degradable material are not identical;
wherein the solid hydrolytically degradable material is selected from the group consisting of: a benzoate ester; a phthalate ester; a lactide; a lactone; a lactam; dextran; chitin; chitosan; a protein; an aliphatic polyester; a poly(lactide); a poly(ε-caprolactone); a poly(hydroxybutyrate); a polyanhydride; an aliphatic polycarbonate; a poly(amide); a poly(urethane); a poly(amino acid); and polyphosphazene; and,
wherein the modifier is a hydrophobic modifier selected from the group consisting of: a linear or branched saturated alkyl; a linear or branched unsaturated alkyl; an alkyldiphenyl ether; a hydrophobic surfactant; polyoxypropylene; polyoxybutylene; a polysiloxane; a perfluoroalkyl; a lignin; a wax; a hydrogenated vegetable oil; a vegetable wax; an animal wax; a synthetic wax; a paraffin wax; a microcrystalline wax; an oil; a hydrocarbon based oil; a vegetable oil; and a silicone oil;
slurrying the solid hydrolytically degradable material coated with the modifier into the treatment fluid; and,
placing the slurry into a subterranean formation;
allowing the modifier to either attract water to or to repel water from the covered hydrolytically degradable material; and
allowing the hydrolytically degradable material to degrade to produce degradation products.
